(19) United States
(12) Patent Application Publication
(10) Pub. No.: US 2009/0071547 A1
(43) Pub. Date: Mar. 19, 2009

(54) STANDPIPE HYDRAULIC FLOAT VALVE

(75) Inventor: Zvi Weingarten, Evron (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: BERMAD CS LTD., Kibbutz Evron (IL)

(21) Appl. No.: 11/857,459

(22) Filed: Sep. 19, 2007

(51) Int. Cl. F16K 21/18

(52) U.S. Cl. 137/398; 137/386

(57) ABSTRACT

The standpipe hydraulic float valve of the present invention employs a mechanical linkage between the float mechanism, which is responsive to changes in the fluid level in the standpipe, and a pilot valve, which regulates a control valve that controls the flow of fluid into the standpipe through its inlet port. Therefore, the mechanical linkage actuates the pilot valve in response to changes in the fluid level in the standpipe so as to provide a substantially continuously variably controlled fluid supply flow into the standpipe housing and thereby maintain a substantially constant fluid level in the standpipe housing so as to maintain a substantially continuous flow pressure into the fluid flow system to which the standpipe hydraulic float valve is connected.

### FIELD AND BACKGROUND OF THE INVENTION

The present invention relates to standpipe float valves and, in particular, it concerns a standpipe float valve that employs a mechanical linkage between the float mechanism and a pilot valve, the mechanical linkage being configured to actuate the pilot valve to regulate a control valve deployed in the supply line upstream from the standpipe inlet port such that the pilot valve and the control valve are deployed at substantially the same height above ground level so as to provide a control system that is substantially free of head pressure that impedes the operation of the main control valve.

It is known to provide low pressure irrigation systems having a standpipe to ensure that the system pressure does not exceed the design pressure for the piping within the system.

The standpipe typically is located upstream of the irrigation system on a ‘T’ off the main supply pipe. Should the pressure of the water entering the standpipe rise above the design value, the water level in the standpipe will rise and overflow the standpipe, spilling out of the open top of the standpipe, thereby protecting the system from damage.

Presently there are numerous automatic hydraulic float control valves installed upstream to the standpipe. The float valve maintains a constant water level in the standpipe thereby regulating the standpipe inflow to match the outflow system's demand. These automatic control valves are configured with their float actuated pilot deployed at the upper region of the standpipe at or above the designed water level within the standpipe. The elevation of the float actuated pilot valve above the hydraulic control valve, which is installed at ground level, produces a permanent water head within the hydraulic control system which applies pressure to the hydraulic control valve. This water head pressure can be sufficient in low water pressure systems such as low pressure irrigation system that the head pressure from the pilot valve may counteract the inlet water supply pressure and therefore prevent the main control valve from full opening, which reduces flow capacity of the main control valve.

There is therefore a need for a standpipe float valve that employs a mechanical linkage between the float mechanism and a pilot valve, the mechanical linkage being configured to actuate the pilot valve so as to regulate a control valve deployed in the supply line upstream from the standpipe inlet port such that the pilot valve and the control valve are deployed at substantially the same height above ground level so as to provide a control system that is substantially free of head pressure that impedes the operation of the main control valve.

### SUMMARY OF THE INVENTION

The present invention is a standpipe float valve that employs a mechanical linkage between the float mechanism and a pilot valve, the mechanical linkage being configured to actuate the pilot valve to regulate a control valve deplyed in the supply line upstream from the standpipe inlet port such that the pilot valve and the control valve are deployed at substantially the same height above ground level so as to provide a control system that is substantially free of head pressure that impedes the operation of the main control valve.

According to the teachings of the present invention there is provided, a standpipe hydraulic float valve for regulating fluid flow, the standpipe float valve comprising: a) a standpipe housing having an inlet port and an outlet port connected to a fluid flow system; b) a float mechanism reactive to a fluid level in the standpipe housing; c) a hydraulic control valve deployed in a fluid supply pipe upstream of the inlet port; d) a pilot valve operationally associated with the control valve, the pilot valve configured regulate the control valve so as to maintain a substantially constant fluid level in the standpipe housing and thereby maintain a substantially continuous flow of pressure into the fluid flow system; and e) a mechanical linkage linking the float mechanism and the pilot valve, the mechanical linkage configured to actuate the pilot valve.

According to a further teaching of the present invention, the control valve is configured to provide substantially continuously variable control of a fluid supply flow entering the standpipe through the inlet port.

According to a further teaching of the present invention, the mechanical linkage includes an actuating rod.

According to a further teaching of the present invention, the actuating rod is mechanically linked at its one end to a float arm of the float mechanism and mechanically linked at its other end to a pilot valve stem element.

According to a further teaching of the present invention, the mechanical linkage includes an actuating cable.

According to a further teaching of the present invention, the actuating cable is mechanically linked at its one end to a float arm of the float mechanism and mechanically linked at its other end to a pilot valve stem element.

According to a further teaching of the present invention, the control valve is controlled by control system that is regulated by the pilot valve.

According to a further teaching of the present invention, the control system is a two-way control loop.

According to a further teaching of the present invention, the pilot valve is deployed at substantially the same height as the control valve.

According to a further teaching of the present invention, the pilot valve is a two-way, normally opened, hydraulically balanced pilot valve driven by a remote mechanical linkage.

According to a further teaching of the present invention, the fluid flow system is an irrigation system.

There is also provided according to the teachings of the present invention, a method for maintaining a fluid level in a standpipe float valve having a standpipe housing configured with an inlet port and an outlet port, a float mechanism reactive to a fluid level within the standpipe housing and a hydraulic control valve deployed in the fluid supply pipe upstream of the inlet port, the method comprising: a) controlling the hydraulic control valve using a two-way control loop regulated by a pilot valve; and b) actuating the pilot valve by use of a mechanical linkage linking the float mechanism to the pilot valve.

According to a further teaching of the present invention, the controlling of the control valve provides a substantially continuously variable control of a supply flow into the standpipe housing.

According to a further teaching of the present invention, the pilot valve is implemented as a two-way normally opened, hydraulically balanced pilot valve.

According to a further teaching of the present invention, the mechanical linkage is implemented so as to include an actuating rod.

According to a further teaching of the present invention, the mechanical linkage is implemented so as to include an actuating cable.

### BRIEF DESCRIPTION OF THE DRAWINGS

The invention is herein described, by way of example only, with reference to the accompanying drawings, wherein:

FIG. 1 is a schematic cut-away side elevation of a first preferred embodiment of a standpipe float valve that employs a mechanical linkage between the float mechanism and a pilot valve constructed and operational according to the teachings of the present invention, shown here with a flexible sheathed cable linkage configured to mechanically link the float mechanism and the pilot valve;

FIG. 2 is a detail of the pilot valve of FIG. 1;

FIG. 3 is a schematic cut-away side elevation of a second preferred embodiment of a standpipe float valve that employs a mechanical linkage between the float mechanism and a pilot valve constructed and operational according to the teachings of the present invention, shown here with an actuating rod linkage configured to mechanically link the float mechanism and the pilot valve; and

FIG. 4 is a detail of the pilot valve of FIG. 3.

### DESCRIPTION OF THE PREFERRED EMBODIMENTS

The present invention is a standpipe float valve that employs a mechanical linkage between the float mechanism and a pilot valve, the mechanical linkage being configured to actuate the pilot valve to regulate a control valve deployed in the supply line upstream from the standpipe inlet port such that the pilot valve and the main flow control valve are deployed at substantially the same height above ground level so as to provide a control system that is substantially free of head pressure that impedes the operation of the main control valve.

The principles and operation of standpipe hydraulic float valve according to the present invention may be better understood with reference to the drawings and the accompanying description.

By way of introduction, the standpipe hydraulic float valve is especially well suited for substantially any application in which it is desirable, if not required, to maintain a predetermined fluid level when providing fluid head-pressure for a fluid delivery system such as, but not limited to, irrigation systems and especially low pressure irrigation system. The standpipe hydraulic float valve of the present invention is configured to provide a substantially continuously variable control of a supply flow into the standpipe housing. It should be noted that although the description herein is directed toward embodiments in which the fluid providing the fluid head-pressure is a standpipe, the principles of the present invention may be applied with equal benefit to embodiments in which the receptacle containing the fluid that is providing the fluid head-pressure is configured other than as a standpipe.

As mentioned above, one drawback to the standpipe float valves of the prior art is the presence of head pressure in the hydraulic control system and particularly in the tubing running between the pilot valve, which is deployed at or above the level of the fluid in the standpipe and main flow control valve that is deployed lower, generally at ground level. This differential in altitude may be sufficient to interfere with the operation of the main flow control valve. Especially in low flow pressure systems in which the inlet flow pressure must overcome the head pressure of the control system in order to open the main flow control valve. This situation may result in the inability of the main flow control valve to be brought to the fully open position.

In order to overcome this problem and provide a standpipe float valve with a main flow control valve that has the capability of being brought to a fully open position allowing maximum flow capacity at very low supply pressure, the present invention is configured such that the pilot valve is deployed at substantially the same height as the main flow control valve. Further, fluid flowing through the control system is vented to atmospheric pressure. This configuration substantially prevents fluid head pressure build-up within the hydraulic control system.

In order to provide remote actuation of the pilot valve, the standpipe float valve of the present invention employs a mechanical linkage between the float mechanism, which is responsive to changes in the fluid level in the standpipe, and a pilot valve, which regulates a hydraulic control valve that controls the flow of fluid into the standpipe through its inlet port. Therefore, the mechanical linkage actuates the pilot valve in response to changes in the fluid level in the standpipe so as to provide a substantially continuously variably controlled fluid supply flow into the standpipe housing and thereby maintain a substantially constant fluid level in the standpipe housing so as to maintain a substantially continuous flow pressure into the fluid flow system to which the standpipe float valve is connected.

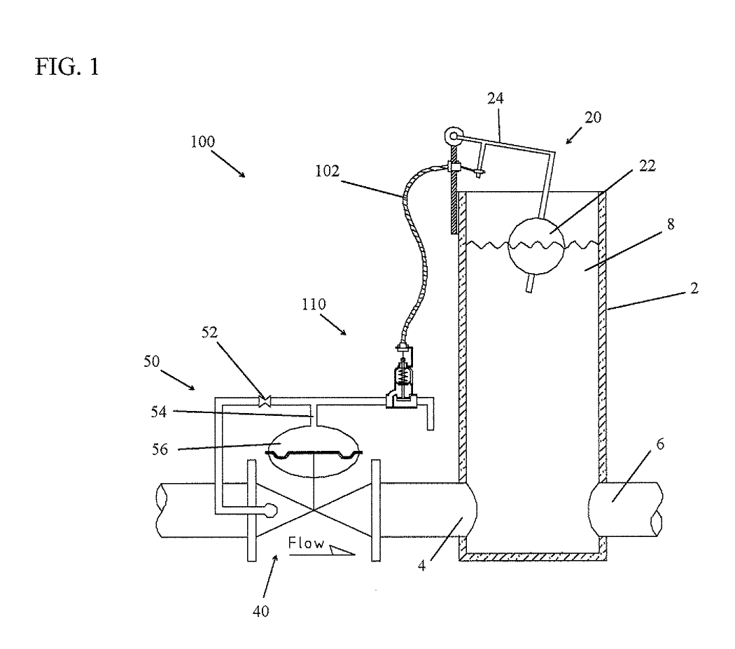

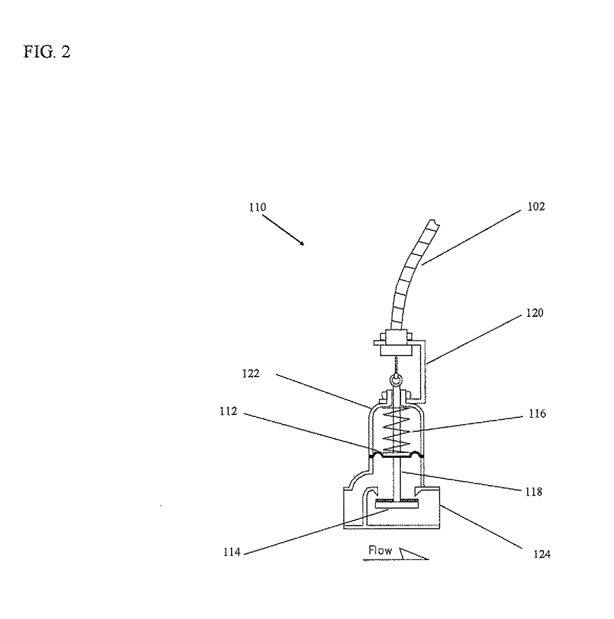

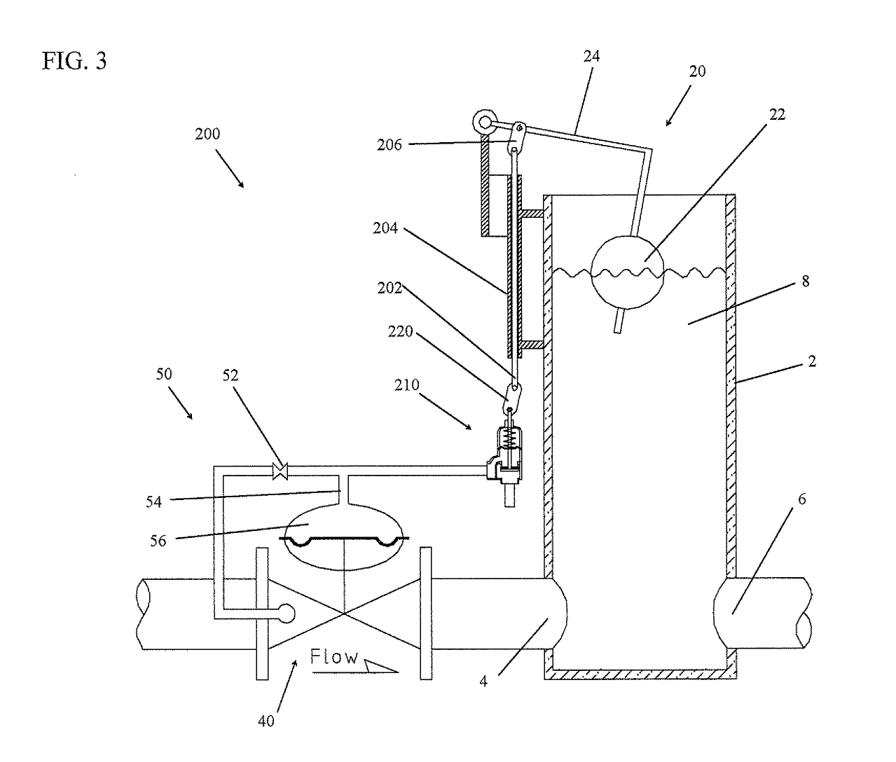

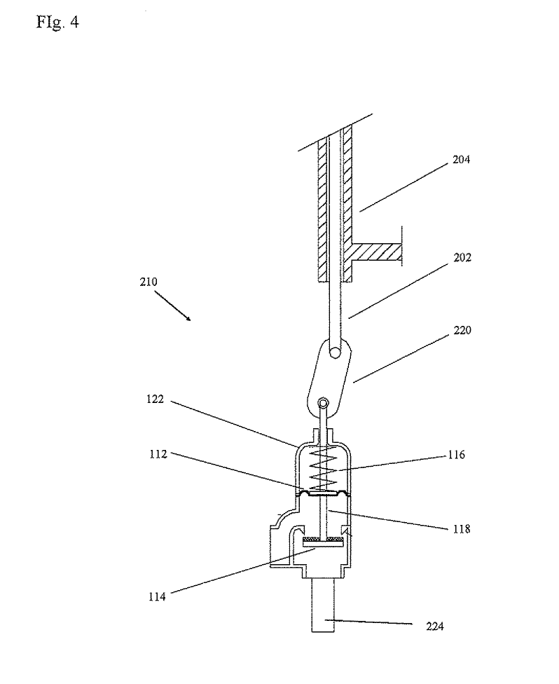

Referring now to the drawings, FIGS. 1 and 2 relate to an embodiment of the standpipe float valve of the present invention in which the mechanical linkage between the float mechanism and the pilot valve is a flexible sheathed cable and FIGS. 3 and 4 relate to an embodiment of the standpipe float valve of the present invention in which the mechanical linkage between the float mechanism and the pilot valve is an actuating rod. It will be appreciated that those structural elements common to both embodiments herein described are numbered the same.

FIG. 1 illustrates a first preferred embodiment of the standpipe hydraulic float valve of the present invention generally referred to as 100. The standpipe float valve includes a standpipe housing 2 having an inlet port 4 and an outlet port 6. Attached at the upper portion of the standpipe housing 2 is a float mechanism 20 with the float 22 deployed so as to float on top of the fluid 8 in the standpipe housing 2. Connected to the float arm 24 of the float mechanism 20 is one end of a flexible sheathed cable 102. The other end of the flexible sheathed cable 102 is connected to the pilot valve 110.

The pilot valve 110 is associated with fluid flow control valve 40 by way of a two-way control loop 50 that includes an upstream pressure restriction orifice 52, a “T” 54 off to the main valve actuator 56 and the pilot valve 110. The fluid flow control valve 40 is deployed in the fluid supply pipe upstream from the inlet port 4.

Preferably, as illustrated in FIG. 2, the pilot valve 110 is configured as a two-way, spring loaded, normally opened, hydraulically balanced pilot valve. It will be appreciated that the hydraulic balance within the pilot valve 110 is achieved because the area of the diaphragm 112 is equal to the area to the pilot valve seat disc 114. The fluid flowing through the pilot valve passes through a region located between the seat disc 114 and diaphragm 112, therefore, the control loop pressure is applied equally to one side each of both the seat disc 114 and diaphragm 112 so as to cancel each others opposite forces, while the opposite sides of both the seat disc 114 and diaphragm 112 are exposed to atmospheric pressure. It will be understood that the interior region of the pilot valve housing 122 in which the spring 116 is deployed is vented to the outside ambient atmospheric pressure and that the pilot valve outlet port 124 is open the outside ambient atmospheric pressure as well.

That is, the force applied to the seat disc 114 by the control loop pressure is off-set by the equal pressure applied to the diaphragm 112 as well, so as to render the pilot valve 110 responsive to the spring 116 and to the movement of the flexible sheathed cable 102 that is actuated by the float mechanism 20. The flexible sheathed cable 102 is attached to the end of the valve stem 118 and held at this end by a bracket 120.

It will be understood that if the upstream pressure rises or the downstream system flow demand decreases, the fluid level in the standpipe will rise. As the float mechanism responds to the change in fluid level the flexible sheathed cable will throttle the pilot valve to close so as to slow or stop the flow of fluid through the pilot valve. This will cause the pressure in the “T” 54, between the restriction orifice 52 and the pilot valve 110 of the two-way control loop 50, to rise forcing the main valve actuator 56 to slow or stop the flow of fluid into the inlet port 4 so as to adjust the standpipe inflow to match the demand of the outflow system connected to the outlet port 6.

Conversely, if the upstream pressure decrease or the downstream system flow demand increases, the fluid level in the standpipe will fall. As the float mechanism responds to the change in fluid level the flexible sheathed cable will throttle the pilot valve to open so as to increase the flow of fluid through the pilot valve. This will cause the pressure in the “T” 54, between the restriction orifice 52 and the pilot valve 110 of the two-way control loop 50 to decrease, allowing the main valve actuator 56 to increase the flow of fluid into the inlet port 4 so as to adjust the standpipe inflow to match the demand of the outflow system connected to the outlet port 6.

FIG. 3 illustrates a second preferred embodiment of the standpipe float valve of the present invention generally referred to as 200. Similar to the embodiment of FIG. 1, this embodiment of the standpipe float valve also includes a standpipe housing 2 having an inlet port 4 and an outlet port 6. Attached at the upper portion of the standpipe housing 2 is a float mechanism 20 with the float 22 deployed so as to float on top of the fluid 8 in the standpipe housing 2. Connected to the float arm 24 of the float mechanism 20 is one end of an actuating rod 202 using a linking element 206. The other end of the actuating rod 202 is connected to the pilot valve 210. Actuating rod 202 is deployed in guide tube 204 that may be attached to the outside of the standpipe housing as illustrated here, however, this is not intended as a limitation to the placement of the guide tube and serves solely as an example.

The pilot valve 210 is likewise associated with fluid hydraulic flow control valve 40 by way of a two-way control loop 50 that includes an upstream pressure restriction orifice 52, a “T” 54 off to the main valve actuator 56 and the pilot valve 110. The fluid flow control valve 40 is deployed in the fluid supply pipe upstream from the inlet port 4.

Preferably, as illustrated in FIG. 4, the pilot valve 210 is configured as a two-way, spring loaded, normally opened, hydraulically balanced pilot valve. It will be appreciated that the hydraulic balance within the pilot valve 210 is achieved because the area of the diaphragm 112 is equal to the area to the pilot valve seat disc 114. The fluid flowing through the pilot valve passes through a region located between the seat disc 114 and diaphragm 112, therefore, the control loop pressure is applied equally to one side each of both the seat disc 114 and diaphragm 112 so as to cancel each others opposite forces, while the opposite sides of both the seat disc 114 and diaphragm 112 are exposed to atmospheric pressure. It will be understood that the interior region of the pilot valve housing 122 in which the spring 116 is deployed is vented to the outside ambient atmospheric pressure and that the pilot valve outlet port 224 is open the outside ambient atmospheric pressure as well.

That is, the force applied to the seat disc 114 by the control loop pressure is off-set by the equal pressure applied to the diaphragm 112 as well, so as to render the pilot valve 110 responsive solely to the spring 116 and to the movement of the actuating rod 202 that is actuated by the float mechanism 20. The actuating rod 202 is attached to the end of the valve stem 118 using a linking element 220.

It will be understood that if the upstream pressure rises or the downstream system flow demand decreases, the fluid level in the standpipe will rise. As the float mechanism responds to the change in fluid level the actuating rod 202 will throttle the pilot valve to close so as to slow or stop the flow of fluid through the pilot valve. This will cause the pressure in the “T” 54, between the restriction orifice 52 and the pilot valve 110 of the two-way control loop 50 to rise, forcing the main valve actuator 56 to slow or stop the flow of fluid into the inlet port 4 so as to adjust the standpipe inflow to match the demand of the outflow system connected to the outlet port 6.

Conversely, if the upstream pressure decreases or the downstream system flow demand increase, the fluid level in the standpipe will fall. As the float mechanism responds to the change in fluid level the flexible sheathed cable will throttle the pilot valve to open so as to increase the flow of fluid through the pilot valve. This will cause the pressure in the “T” 54, between the restriction orifice 52 and the pilot valve 110 of the two-way control loop 50 to decrease, allowing the main valve actuator 56 to open further and thereby increase the flow of fluid into the inlet port 4 so as to adjust the standpipe inflow to match the demand of the outflow system connected to the outlet port 6.

It will be appreciated that the above descriptions are intended only to serve as examples and that many other embodiments are possible within the spirit and the scope of the present invention.

What is claimed is:

1. A standpipe hydraulic float valve for regulating fluid flow, the standpipe float valve comprising:
(a) a standpipe housing having an inlet port and an outlet port connected to a fluid flow system;
(b) a float mechanism reactive to a fluid level in said standpipe housing;
(c) a hydraulic control valve deployed in a fluid supply pipe upstream of said inlet port;
(d) a pilot valve operationally associated with said control valve, said pilot valve configured regulate said control valve so as to maintain a substantially constant fluid level in said standpipe housing and thereby maintain a substantially continuous flow of pressure into said fluid flow system; and
(e) a mechanical linkage linking said float mechanism and said pilot valve, said mechanical linkage configured to actuate said pilot valve.

2. The standpipe hydraulic float valve of claim 1, wherein said control valve is configured to provide substantially continuously variable control of a fluid supply flow entering said standpipe through said inlet port.

3. The standpipe hydraulic float valve of claim 1, wherein said mechanical linkage includes an actuating rod.

4. The standpipe float valve of claim 3, wherein said actuating rod is mechanically linked at its one end to a float arm of said float mechanism and mechanically linked at its other end to a pilot valve stem element.

5. The standpipe float valve of claim 1, wherein said mechanical linkage includes an actuating cable.

6. The standpipe hydraulic float valve of claim 5, wherein said actuating cable is mechanically linked at its one end to a float arm of said float mechanism and mechanically linked at its other end to a pilot valve stem element.

7. The standpipe float valve of claim 1, wherein said control valve is controlled by control system that is regulated by said pilot valve

8. The standpipe float valve of claim 7, wherein said control system is a two-way control loop.

9. The standpipe float valve of claim 7, wherein said pilot valve is deployed at substantially the same height as said control valve.

10. The standpipe float valve of claim 1, wherein said pilot valve is a two-way, normally opened, hydraulically balanced pilot valve driven by a remote mechanical linkage.

11. The standpipe hydraulic float valve of claim 1, wherein said fluid flow system is an irrigation system.

12. A method for maintaining a fluid level in a standpipe float valve having a standpipe housing configured with an inlet port and an outlet port, a float mechanism reactive to a fluid level within the standpipe housing and a hydraulic control valve deployed in the fluid supply pipe upstream of the inlet port, the method comprising:
(a) controlling the hydraulic control valve using a two-way control loop regulated by a pilot valve; and
(b) actuating said pilot valve by use of a mechanical linkage linking the float mechanism to said pilot valve.

13. The method of claim 12, wherein said controlling of said control valve provides a substantially continuously variable control of a supply flow into the standpipe housing.

14. The method of claim 12, wherein said pilot valve is implemented as a two-way normally opened, hydraulically balanced pilot valve.

15. The method of claim 12, wherein said mechanical linkage is implemented so as to include an actuating rod.

16. The method of claim 12, wherein said mechanical linkage is implemented so as to include an actuating cable.
